(19) United States
(12) Patent Application Publication
(10) Pub. No.: US 2008/0078183 A1
(43) Pub. Date: Apr. 3, 2008

(54) Liquid fuel enhancement for natural gas swirl stabilized nozzle and method

(75) Inventors: Willy Steve Ziminsky, Greenville, SC (US); Vaibhav Nadkarni, Ujjain (IN); Atul Kumar Vij, Bangalore (IN)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 11/541,704

(22) Filed: Oct. 3, 2006

(51) Int. Cl. F02C 7/26

(52) U.S. Cl. 60/776; 60/737

(57) ABSTRACT

Conventional swozzle-type burners are modified so as to be capable of selectively running on liquid fuel without requiring water injection for NOx abatement or dedicated air supply for atomizing liquid fuel.

### BACKGROUND OF THE INVENTION

Gas turbine manufacturers are regularly involved in research and engineering programs to produce new gas turbines that will operate at high efficiency without producing undesirable air polluting emissions. The primary air polluting emissions usually produced by gas turbines burning conventional hydrocarbon fuels are oxides of nitrogen, carbon monoxide, and unburned hydrocarbons. In general, engine emissions fall into two classes: those formed because of high flame temperatures (NOx), and those formed because of low flame temperatures which do not allow the fuel-air reaction to proceed to completion (HC & CO).

One preferred method of controlling the temperature of the reaction zone of a heat engine combustor below the level at which thermal NOx is formed is to premix fuel and air to a lean mixture prior to combustion. The thermal mass of the excess air present in the reaction zone of a lean premixed combustor absorbs heat and reduces the temperature rise of the products of combustion to a level where thermal NOx is not formed.

Gas turbines for power generation are generally available with fuel nozzles configured for either “Dual Fuel” or “Gas Only”. “Gas Only” refers to operation burning, for example, natural gas and “Dual Fuel” refers to having the capability of operation burning either natural gas or liquid fuel. The “Dual Fuel” configuration is generally applied with oil used as a backup fuel, if natural gas is unavailable. The “Gas Only” configuration is offered in order to reduce costs as the nozzle parts and all associated equipment required for liquid fuel operation are not supplied. In general, fuel nozzles are designed to have “Dual Fuel” capability and the “Gas Only” version is a modification to the dual fuel design in which the liquid fuel parts are omitted from the nozzle and replaced with a component of similar size and shape, but without the internal features of the liquid fuel cartridge. This replacement component is known as a “Gas-Only Insert.” FIG. 1 illustrates a conventional water/oil/atomizing air cartridge, including the oil, atomizing air and water inlets 101, 103, 105, and passages 102, 104, 106.

Referring to FIG. 2, an example of a swozzle type burner is schematically depicted. Air enters the burner 110 at 112, from a high pressure plenum, which surrounds the assembly, except the discharge end 114 which enters the combustor reaction zone.

After passing through the inlet 112, the air enters the swirler or “swozzle” assembly 116. The swozzle assembly includes a hub 118 (e.g., the center body) and a shroud 120 connected by a series of air foil shaped turning vanes 122 which impart swirl to the combustion air passing through the premixer. Each turning vane 122 includes gas fuel supply passage(s) 124 through the core of the air foil. These fuel passages distribute gas fuel to gas fuel injection holes (not shown in FIG. 2) which penetrate the wall of the air foil. Gas fuel enters the swozzle assembly through inlet port(s) and annular passage(s) 126, which feed the turning vane passages 124. The gas fuel begins mixing with combustion air in the swozzle assembly 128, and fuel/air mixing is completed in the annular passage 130, which is formed by a center body extension 132 and a swozzle shroud extension 134. After exiting the annular passage, the fuel/air mixture enters the combustor reaction zone where combustion takes place.

### BRIEF DESCRIPTION OF THE INVENTION

The present invention provides a modification to conventional swozzle-type burners to make them capable of running on liquid fuel without requiring water injection for NOx abatement or a dedicated air supply for atomizing liquid fuel.

Thus, the invention may be embodied in a burner for use in a combustion system of a gas turbine, the burner comprising: an outer peripheral wall; a burner center body coaxially disposed within said outer wall; and a fuel/air premixer including an air inlet, at least one gas fuel injection hole, at least one liquid fuel injection opening, and an annular mixing passage, the fuel/air premixer selectively mixing gas fuel and air or liquid fuel and air in the annular mixing passage for injection into a combustor reaction zone, wherein the fuel/air premixer comprises a swozzle assembly downstream of the air inlet, the swozzle assembly including a plurality of swozzle assembly turning vanes imparting swirl to the incoming air and wherein each of the swozzle assembly turning vanes comprises an internal gas fuel flow passage in communication with said at least one gas fuel injection hole, a gas fuel inlet introducing gas fuel into the internal gas fuel flow passages, and wherein the swozzle assembly further comprises an internal liquid fuel flow passage in communication with said at least one liquid fuel injection opening, and a liquid fuel inlet introducing liquid fuel into the internal liquid fuel flow passage.

The invention may also be embodied in a method of premixing fuel and air in a burner for a combustion system of a gas turbine, the burner including an outer peripheral wall; a burner center body coaxially disposed within said outer wall; and a fuel/air premixer including an air inlet, at least one gas fuel injection hole, at least one liquid fuel injection opening, and an annular mixing passage, wherein the fuel/air premixer comprises a swozzle assembly downstream of the air inlet, the swozzle assembly including a plurality of swozzle assembly turning vanes and wherein each of the swozzle assembly turning vanes comprises an internal gas fuel flow passage in communication with said at least one gas fuel injection hole, and a gas fuel inlet introducing gas fuel into the internal gas fuel flow passages, and wherein the swozzle assembly further comprises an internal liquid fuel flow passage in communication with said at least one liquid fuel injection opening, and a liquid fuel inlet introducing liquid fuel into the internal liquid fuel flow passage, the method comprising: distributing incoming air about the center body upstream of the swozzle assembly; imparting swirl to the incoming air with the swozzle assembly turning vanes; and mixing at least one of gas and liquid fuel with air in the annular mixing passage for injection into a combustor reaction zone by independently controlling gas and liquid flow through the primary fuel passage and secondary fuel passage and into the annular mixing passage.

### BRIEF DESCRIPTION OF THE DRAWINGS

FIG. 1 is a cross-section through a conventional water/oil/atomizing air cartridge;

FIG. 2 is a schematic illustration, partly in cross-section, of a conventional swozzle type burner;

FIG. 3 is a cross-section through the burner which may incorporate the liquid fuel feed of the invention;

FIG. 4 schematically illustrates a modified liquid fuel cartridge for the burner of FIG. 3;

FIGS. 5 and 6 schematically show details of the air swirler assembly with fuel injection through the turning vanes;

FIG. 7 is a schematic perspective view illustrating liquid fuel vane injection according to one example embodiment of the invention;

FIG. 8 is a cross-section along line 8-8 of FIG. 7 showing the liquid fuel nozzle tip secured to the vane;

FIG. 9 is a schematic cross-section of a vane showing liquid fuel injection according to another example embodiment of the invention; and

FIG. 10 is a schematic cross-section of a center body and vanes illustrating liquid fuel injection according to yet another example embodiment of the invention.

### DETAILED DESCRIPTION OF THE INVENTION

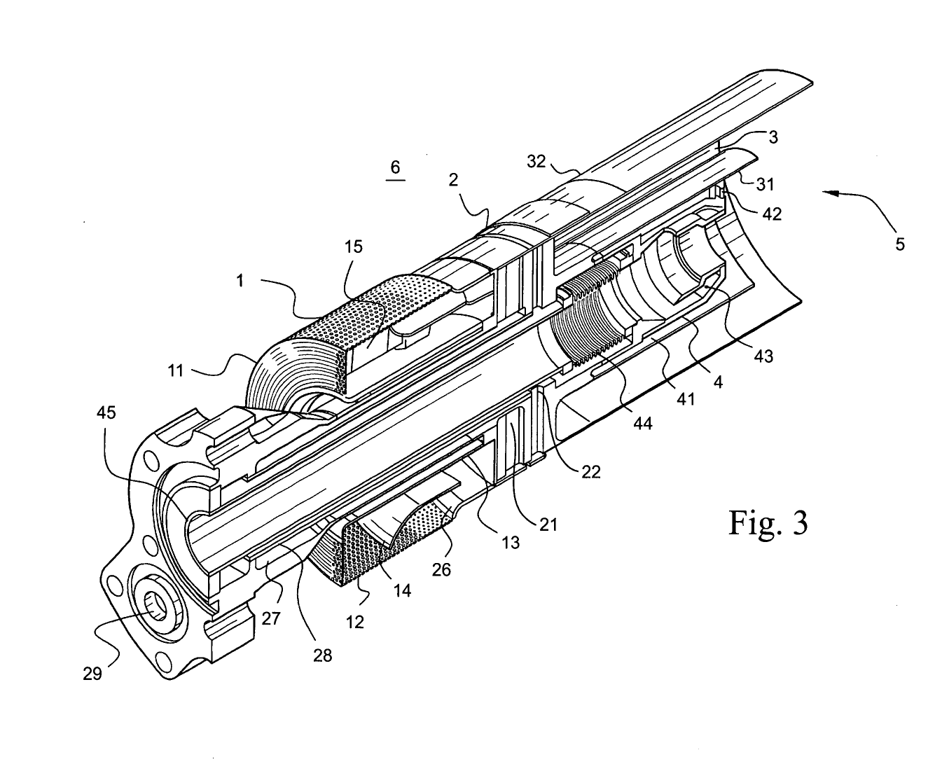

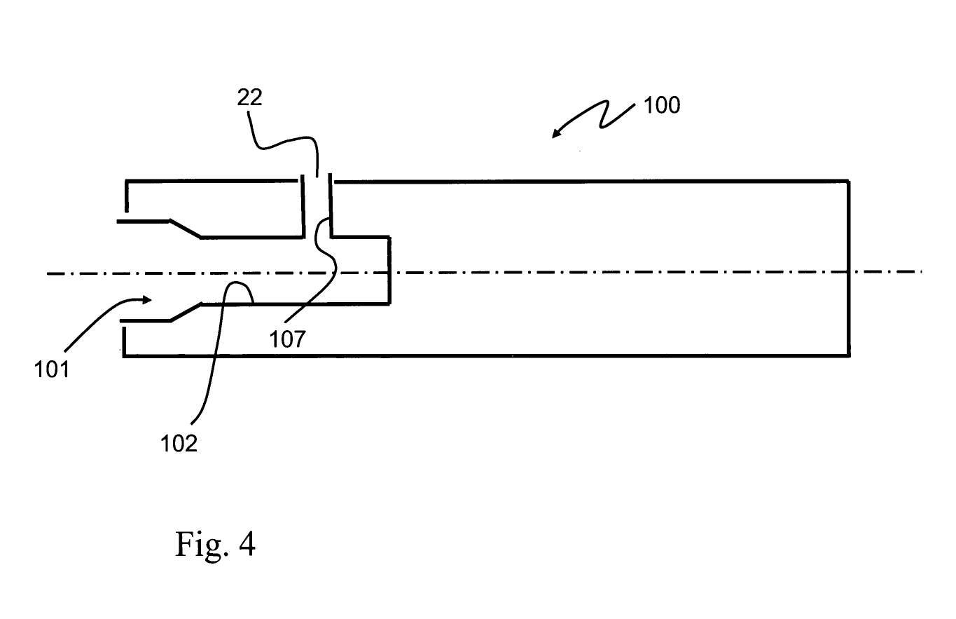

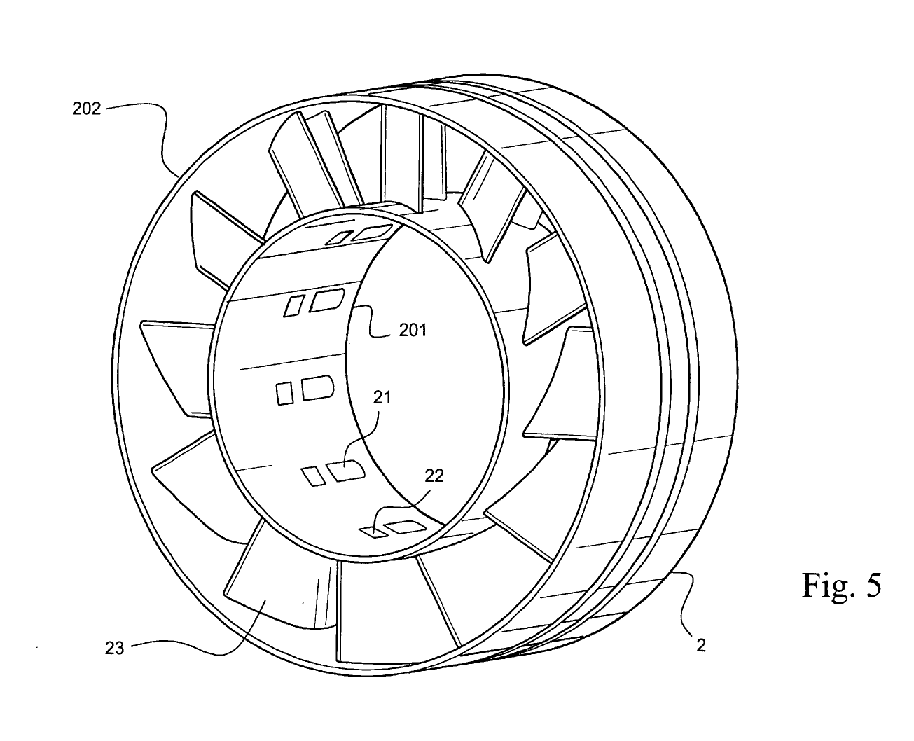

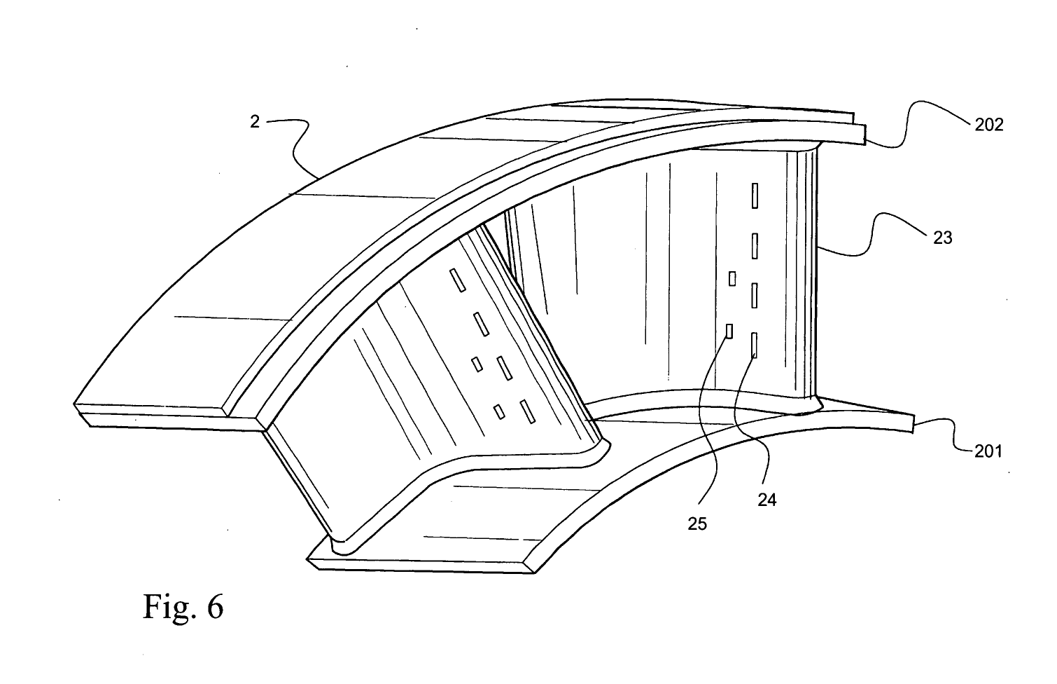

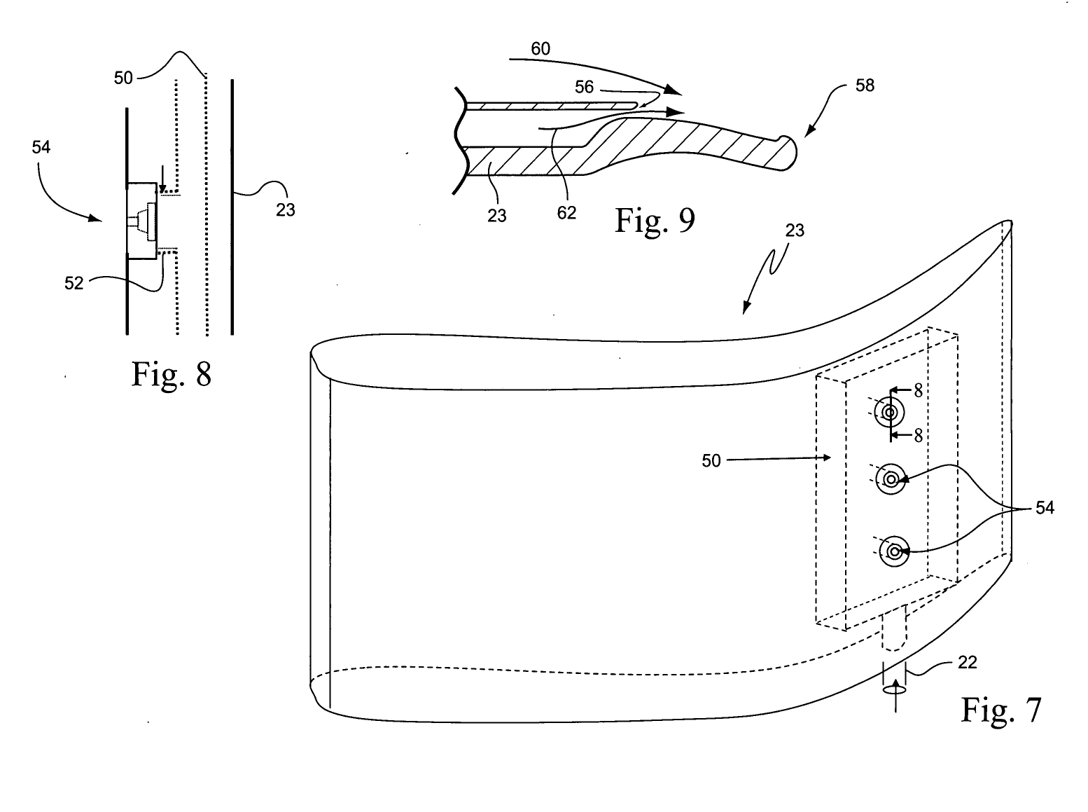

FIG. 3 is a cross-section through an example burner in which the invention may be adopted and FIG. 4 schematically illustrates a modified liquid fuel cartridge therefor. FIGS. 5 and 6 show details of the air swirler assembly with fuel injection through the turning vanes or swozzle, and FIGS. 7-8, 9, and 10 illustrate example liquid fuel injection ports according to example embodiments of the invention.

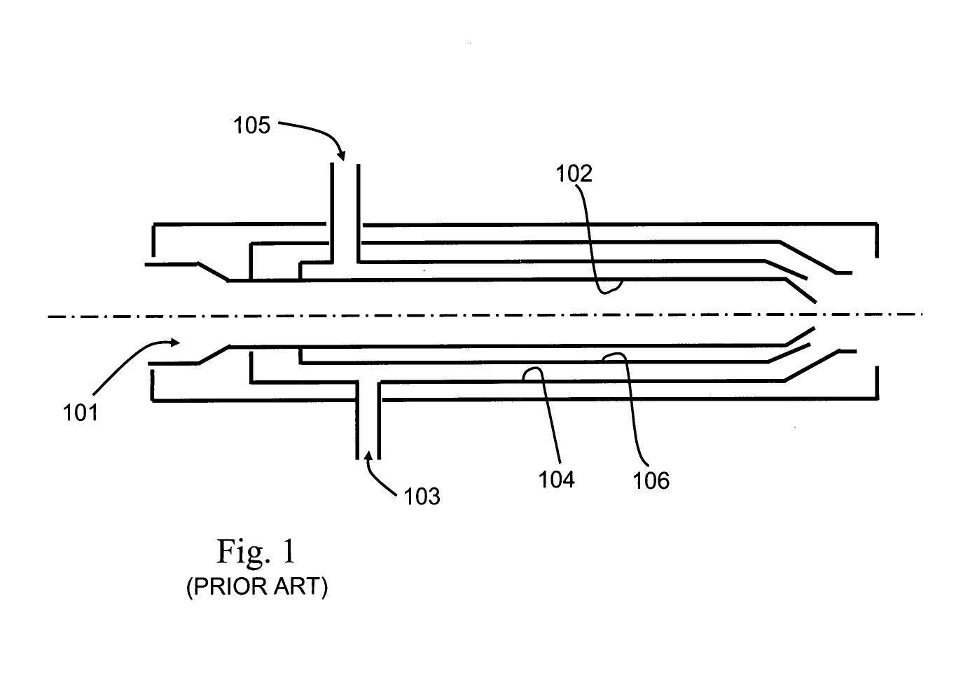

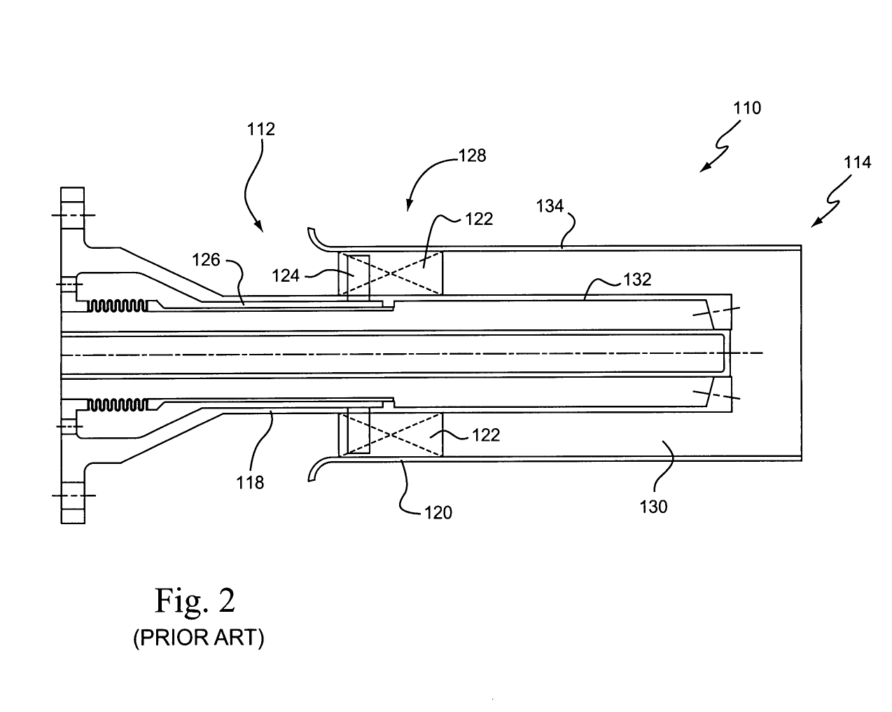

Because the invention proposes to inject liquid fuel through or in the vicinity of the swozzle vanes, the prior art liquid fuel/water/atomizing air cartridge (FIG. 1) is modified according to example embodiments of the invention. For example, referring to the schematic illustration of FIG. 4, the atomizing air and water passages 104, 106 are no longer required and the central liquid fuel passage 102 of the cartridge 100 is connected through radially outward passages 107 to the vanes, as described in greater detail below. The modified liquid fuel cartridge 100 is omitted from the burner illustrated in FIG. 3 for clarity.

The burner assembly is divided into four regions by function including an inlet flow conditioner 1, an air swirler assembly with fuel injection (swozzle assembly) 2, an annular fuel air mixing passage 3, and a central diffusion flame natural gas fuel nozzle assembly 4.

Air enters the burner from a high pressure plenum 6, which surrounds the entire assembly except the discharge end, which enters the combustor reaction zone 5. Most of the air for combustion enters the premixer via the inlet flow conditioner (IFC) 1. The IFC includes an annular flow passage 15 that is bounded by a solid cylindrical inner wall 13 at the inside diameter, a perforated cylindrical outer wall 12 at the outside diameter, and a perforated end cap 11 at the upstream end. In the center of the flow passage 15 is one or more annular turning vanes 14. Premixer air enters the IFC 1 via the perforations in the end cap and cylindrical outer wall.

The function of the IFC 1 is to prepare the air flow velocity distribution for entry into the premixer. The principle of the IFC 1 is based on the concept of backpressuring the premix air before it enters the premixer. This allows for better angular distribution of premix air flow. The perforated walls 11, 12 perform the function of backpressuring the system and evenly distributing the flow circumferentially around the IFC annulus 15, whereas the turning vane(s) 14, work in conjunction with the perforated walls to produce proper radial distribution of incoming air in the IFC annulus 15. Depending on the desired flow distribution within the premixer as well as flow splits among individual premixers for a multiple burner combustor, appropriate hole patterns for the perforated walls are selected in conjunction with axial position of the turning vane(s) 14. A computer fluid dynamic code is used to calculate flow distribution to determine an appropriate hole pattern for the perforated walls. A suitable computer program for this purpose is entitled STAR CD by Adapco of Long Island, N.Y.

To eliminate low velocity regions near the shroud wall 202 at the inlet to the swozzle 2, a bell-mouth shaped transition 26 is used between the IFC and the swozzle.

Experience with multi-burner dry low emissions combustion systems in heavy-duty industrial gas turbine applications has shown that non-uniform air flow distribution exists in the plenum 6 surrounding the burners. This can lead to non-uniform air flow distribution among burners or substantial air flow maldistribution within the premixer annulus. The result of this air flow maldistribution is fuel/mixture strength maldistribution entering the reaction zone of the combustor, which in turn results in degradation of emissions performance. To the extent that the IFC 1 improves the uniformity of air flow distribution among burners and within the premixer annulus of individual burners, it also improves the emissions performance of the entire combustion system and the gas turbine.

After combustion air exits the IFC 1, it enters the swozzle assembly 2. The swozzle assembly includes a hub 18 and a shroud 20 connected by a series of air foil shaped turning vanes 23 which impart swirl to the combustion air passing through the premixer. In an example embodiment of the invention, each turning vane 23 contains a primary, natural gas fuel supply passage 21 and a secondary, liquid fuel supply passage 22 through the core of the air foil. These fuel passages distribute natural gas fuel to primary fuel injection holes 24 and liquid fuel to secondary fuel injection holes 25, which penetrate the wall of the air foil. These fuel injection holes may be located on the pressure side, the suction side, or both sides of the turning vanes 23. Natural gas fuel enters the swozzle assembly 2 through inlet port 29 and annular passage 27 which feeds the primary turning vane passages 21. Liquid fuel enters through a suitable inlet port (not shown) and annular passage 28 which feeds the secondary turning vane passages 22. Alternatively liquid fuel is fed through a liquid fuel cartridge as described above and illustrated in FIG. 4. The gas or liquid fuel according to the selected operation begins mixing with combustion air in the swozzle assembly, and fuel/air mixing is completed in the annular passage 3, which is formed by a swozzle hub extension 31 and a swozzle shroud extension 32. After exiting the annular passage 3, the fuel/air mixture enters the combustor reaction zone 5 where combustion takes place.

Since the swozzle assembly 2 injects the natural gas fuel or the liquid fuel through the surface of aerodynamic turning vanes (airfoils) 23, the disturbance to the air flow field is minimized. The use of this geometry does not create any regions of flow stagnation or separation/recirculation in the premixer after fuel injection into the air stream. Secondary flows are also minimized with this geometry with the result that control of fuel/air mixing and mixture distribution profile is facilitated. The flow field remains aerodynamically clean from the region of fuel injection to the premixer discharge into the combustor reaction zone 5. In the reaction zone, the swirl induced by the swozzle 2 causes a central vortex to form with flow recirculation. This stabilizes the flame front in the reaction zone 5. However, as long as the velocity in the premixer remains above the turbulent flame propagation speed, flame will not propagate into the premixer (flashback); and, with no flow separation or recirculation in the premixer, flame will not anchor in the premixer in the event of a transient causing flow reversal. The capability of the swozzle 2 to resist flashback and flame holding is extremely important for application since occurrence of these phenomena would cause the premixer to overheat with subsequent damage.

FIGS. 5 and 6 show details of the swozzle geometry. As noted, there are two groups of fuel injection holes on the surface of each turning vane 23, including the primary, gas fuel injection holes 24 and the secondary, liquid fuel injection holes 25. Fuel is fed to these fuel injection holes 24, 25 through the primary, gas fuel passage 21 and the secondary, liquid fuel passage 22. Fuel flow through these two injection paths is controlled independently.

The invention takes advantage of the above-described existing design of the swozzle to make it capable of running on liquid fuel so that water injection is not required for NOx abatement and dedicated air supply is not required for atomizing liquid fuel. In this regard, the swozzle swirler structure is a dual core hollow casting where both internal passages 21, 22 have conventionally been used for gas fuel only. In accordance with an example embodiment of the invention, one of the existing internal passages or cores 22 is modified for use for injecting liquid fuel through a modified swirler vane in the manner of an air blast/pressure atomizer.

An embodiment of the modified swozzle vane is depicted by way of example in FIGS. 7 and 8. For ease of illustration, the primary, gas fuel passage(s) and injection hole(s) are omitted from FIG. 7. Thus, FIG. 7 is a schematic perspective view of the swirler vane 23 illustrating in phantom a liquid fuel passage 22 disposed to extend from the center body (not shown) to a pressurized fuel chamber 50 cast in the vane. A plurality of fuel outlets 52 are defined in the pressurized fuel chamber for respectively threadably receiving pressure swirl nozzle tips 54. The nozzle tips are threaded so as to be disposed substantially flush with the surface of the vane, as illustrated in FIG. 8 which is a cross-sectional view along line 8-8 of FIG. 7. The fine droplets emitted as atomized liquid fuel from the nozzle tips of the swirler vanes evaporate as they travel the final length of the burner tube and ultimately combust in a premixed mode.

Another example embodiment of a modified swozzle vane according to the invention is depicted in FIG. 9. In this embodiment, a slot 56 releases fuel from the vane 23. As illustrated, the slot is actually upstream of the trailing edge 58 and utilizes the airblast effect of the incoming air 60 to atomize the fuel 62 released from the slot.

Thus, the intention is to inject fuel through the swirler vanes instead of the central fuel nozzle. This provides a highly distributed source of liquid fuel compared to the conventional swozzle design. Since there are several vanes and the fuel is more highly distributed than when injected through the center fuel nozzle, it can potentially atomize due to the interaction with the incoming combustion air and no specially pressurized atomizing air stream is required. In one embodiment, as illustrated in FIGS. 7-8, distributed fuel injection pressure atomizers are connected to the pressurized fuel chamber cast inside each respective vane. The atomizer sits flush with the outside surface, e.g., on the suction side of each vane. The fuel from the atomizers is thus released as a hollow cone spray which evaporates on interaction with the compressor discharge air (combustion air). The fuel-air mixing level increases as the mixture travels downstream through the vanes. In another embodiment, as illustrated in FIG. 9, a slot is cut near the trailing edge of the swirler vanes to release liquid fuel from each vane or symmetrically disposed vanes.

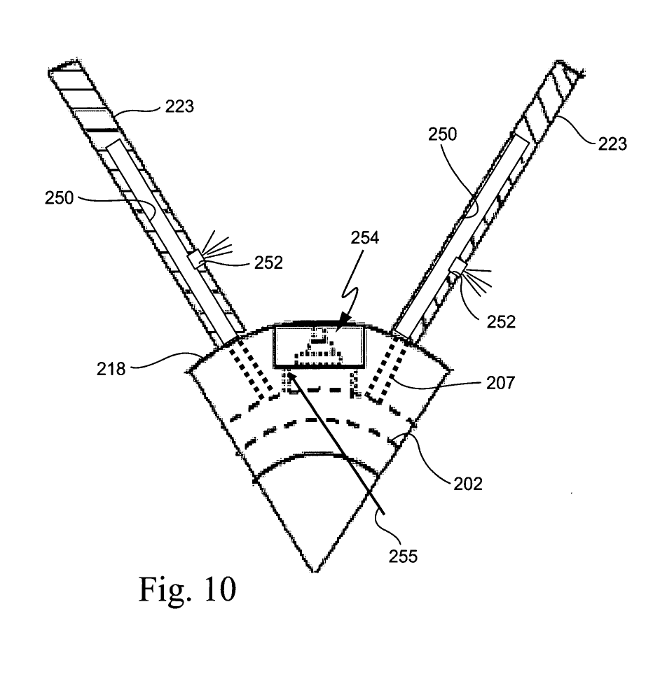

The location, number and characteristics of the atomizers and/or slots can be optimized for achieving the desired fuel-air mixing level at the diffusion tip location which is downstream of the vanes trailing edge. It may be noted that some or all of the atomizers may be placed on the center body between the vanes as opposed on the vanes themselves or an addition thereto, thus allowing even more flexibility in achieving optimum fuel-air mixing. This alternative is illustrated in FIG. 10. As illustrated therein, a pressurized fuel passage 202 is defined in the center body 218 and communicates with pressurized chambers 250 in the swirler vanes 223 via passages 207. Additionally, a nozzle tip 254 is threaded to a threaded hole 255 in the center body 218 so as to be in direct communication with the pressurized fuel passage 202. Thus, liquid fuel injection in this embodiment is from both the nozzle tip 254 on the center body outer wall and from the vanes at 252.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A burner for use in a combustion system of a gas turbine, the burner comprising:
an outer peripheral wall;
a burner center body coaxially disposed within said outer wall; and
a fuel/air premixer including an air inlet, at least one gas fuel injection hole, at least one liquid fuel injection opening, and an annular mixing passage, the fuel/air premixer selectively mixing gas fuel and air or liquid fuel and air in the annular mixing passage for injection into a combustor reaction zone, wherein the fuel/air premixer comprises a swozzle assembly downstream of the air inlet, the swozzle assembly including a plurality of swozzle assembly turning vanes imparting swirl to the incoming air and wherein each of the swozzle assembly turning vanes comprises an internal gas fuel flow passage in communication with said at least one gas fuel injection hole, a gas fuel inlet introducing gas fuel into the internal gas fuel flow passages, and wherein the swozzle assembly further comprises an internal liquid fuel flow passage in communication with said at least one liquid fuel injection opening, and a liquid fuel inlet introducing liquid fuel into the internal liquid fuel flow passage.

2. A burner as in claim 1, wherein at least one liquid fuel injection opening is defined in at least one swozzle assembly turning vane.

3. A burner as in claim 2, wherein said internal liquid fuel flow passage in communication with said at least one liquid fuel injection opening includes a pressurized liquid fuel chamber in said respective vane.

4. A burner as in claim 2, wherein said at least one liquid fuel injection opening has a liquid fuel nozzle tip for injecting atomized liquid fuel into said annular mixing passage.

5. A burner as in claim 2, wherein said at least one liquid fuel injection opening comprises a slot for releasing fuel from the vane.

6. A burner as in claim 1, wherein at least one liquid fuel injection opening is defined in an outer wall of the center body.

7. A burner as in claim 1, wherein said internal liquid fuel flow passage comprises a pressurized liquid fuel chamber and wherein there are a plurality of nozzle tips for injecting atomized liquid fuel from the pressurized fuel chamber into the annular mixing passage.

8. A method of premixing fuel and air in a burner for a combustion system of a gas turbine, the burner including an outer peripheral wall; a burner center body coaxially disposed within said outer wall; and a fuel/air premixer including an air inlet, at least one gas fuel injection hole, at least one liquid fuel injection opening, and an annular mixing passage, wherein the fuel/air premixer comprises a swozzle assembly downstream of the air inlet, the swozzle assembly including a plurality of swozzle assembly turning vanes and wherein each of the swozzle assembly turning vanes comprises an internal gas fuel flow passage in communication with said at least one gas fuel injection hole, and a gas fuel inlet introducing gas fuel into the internal gas fuel flow passages, and wherein the swozzle assembly further comprises an internal liquid fuel flow passage in communication with said at least one liquid fuel injection opening, and a liquid fuel inlet introducing liquid fuel into the internal liquid fuel flow passage, the method comprising:
distributing incoming air about the center body upstream of the swozzle assembly;
imparting swirl to the incoming air with the swozzle assembly turning vanes; and
mixing at least one of gas and liquid fuel with air in the annular mixing passage for injection into a combustor reaction zone by independently controlling gas and liquid flow through the primary fuel passage and secondary fuel passage and into the annular mixing passage.

9. A method as in claim 8, wherein at least one liquid fuel injection opening is defined in at least one swozzle assembly turning vane.

10. A method as in claim 9, wherein said internal liquid fuel flow passage in communication with said at least one liquid fuel injection opening includes a pressurized liquid fuel chamber in said respective vane.

11. A method as in claim 9, wherein said at least one liquid fuel injection opening has a liquid fuel nozzle tip for injecting atomized liquid fuel into said annular mixing passage.

12. A method as in claim 9, wherein said at least one liquid fuel injection opening comprises a slot for releasing fuel from the vane upstream of the trailing edge, wherein incoming air atomizes the fuel released from the slot.

13. A method as in claim 8, wherein at least one liquid fuel injection opening is defined in an outer wall of the center body.

14. A method as in claim 8, wherein said internal liquid fuel flow passage comprises a pressurized liquid fuel chamber and wherein there are a plurality of nozzle tips for injecting atomized liquid fuel from the pressurized fuel chamber into the annular mixing passage.
